(19) United States
(12) Patent Application Publication
(10) Pub. No.: US 2005/0068656 A1
(43) Pub. Date: Mar. 31, 2005

(54) Disk drive including an auxiliary pulse width modulation (PWM) control circuit and related methods

(75) Inventors: Alberto Salina, Limbiate (IT); Roberto Peritore, Rosate (IT); Fabio Ramaioli, Melegnano (IT)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: STMicroelectronics S.r.l., Agrate Brianza (IT)

(21) Appl. No.: 10/672,925

(22) Filed: Sep. 26, 2003

(51) Int. Cl. G11B 21/02

(52) U.S. Cl. 360/75

(57) ABSTRACT

A disk drive may include a housing, and a rotatable data storage disk and associated disk drive motor carried by the housing for rotating the rotatable data storage disk. The disk drive may also include a movable arm and associated arm drive motor carried by the housing for moving the arm adjacent to the rotatable data storage disk. Further, at least one read/write head may be carried by the arm, and a driving circuit may be included for the arm drive motor. The driving circuit may include at least one output stage connected to a power supply for driving the arm drive motor, at least one capacitor connected to the power supply, and an auxiliary pulse width modulation (PWM) control circuit connected to the at least one capacitor for driving the at least one output stage in a PWM mode after the power supply is switched off.

### FIELD OF THE INVENTION

The present invention relates to circuits for controlling electromagnetic actuators and, more particularly, for controlling a voice coil motor (VCM) for positioning the arm carrying read/write heads of a disk drive.

### BACKGROUND OF THE INVENTION

When a disk drive is switched off, such as a common hard disk drive (HDD) of a personal computer (PC), for example, the arm carrying the read/write heads over the disk is moved away to a safe position on a parking ramp. This is done to reduce the possibility of damaging the disk surface as a result of vibrations and/or impacts when the apparatus is not in use.

This operation is typically called “ramp unloading,” as opposed to the inverse operation of “ramp loading” which is performed when the drive is turned on to read data stored on the disk. Control systems specifically designed for HDDs are well known in the art. By way of example, U.S. Pat. No. 6,542,324 discloses a drive system for the voice coil motor (VCM) of a HDD drive that uses a full bridge output stage for driving the motor.

The system disclosed in the above-noted patent, as well as those typically used in HDDs, commonly include a driving circuit for powering the VCM to perform the required ramp unloading operation upon turning off the power supply connected to the HDD (e.g., turning off the PC). In desktops PCs, for example, the power required to move the VCM to the parking position on the ramp of the arm carrying the read/write heads is derived from the back electromotive force (BEMF) generated in the motor that rotates the disk. By inertia, the disk continues to rotate for a certain period of time after switching off the power supply.

In disk drives designed for relatively low supply voltages, such as battery powered portable PCs (i.e., laptops), digital cameras, video cameras, etc., the BEMF voltage of the motor that rotates the disk is often insufficient to power the ramp unloading phase. Accordingly, in these and other devices having disk drives of particularly small dimensions, it is common to use a rather large capacitor that can accumulate enough energy to drive the VCM to complete the ramp unloading after switching off the power supply.

This type of prior art configuration is shown in FIG. 1. The energy stored in the dedicated capacitor C is generally charged at a boosted voltage. The boosted voltage is typically available within the integrated control circuit for more efficiently driving the high-side device(s) of the output stage, or it may be specifically generated by a dedicated charge pump. The stored energy is transferred to the VCM, which moves the arm carrying the heads, through a classical linear voltage regulator. For this configuration, the maximum duration of the parking phase that may be powered with the storage capacitor C is given by the following expression:
T=(V_{cap}−V_{CVR})*C/I_{VCM}=(V_{cap}−V_{CVR})*C*R_{VCM}/V_{CVR}; (1)
where V_{cap} is the initial voltage on the storage capacitor C after turning off the power supply, V_{CVR} is the regulated voltage to be applied to the VCM, I_{VCM} is the VCM current, R_{VCM} is the equivalent resistance of the VCM, and C is the capacitance of the storage capacitor.

As will be appreciated by those skilled in the art, the order of magnitude of the power required to be transferred to the VCM after turning off the power supply for allowing it to move the head-carrying arm up the parking ramp is fairly significant. So much so that it requires the use of a capacitor having a relatively large capacitance value, which necessarily makes this capacitor external to the integrated control circuit of the drive (including the VCM).

In the case of micro-drives (μDrive), e.g., those commonly used in portable devices such as digital video cameras, the requisite energy for parking the VCM is such that a storing capacitance in the order of several tens of microfarads (μF) is required. More particularly, in a typical application of this type the capacitance values used is about 66 μF.

Yet, micro-drives have stringent requirements with respect to compactness and, specifically, thickness. That is, these devices typically need to be as shallow as possible because of the limited space within the apparatus housing. However, the cost of storage capacitors that can fit within these space constraints is relatively high.

The small thickness requirement of the complete drive assembly makes the encumbrance problem of these externally connected storage capacitors even more severe. Two or more capacitors often are connected in parallel to make up for the total capacitance required, which further adds to the relatively high cost of these components. As a result, it is not uncommon that the costs of these external capacitors is higher than the cost of the integrated device including the control system of the drive motors. As a result, there is a need to reduce the cost burden of these storage capacitors in disk drives, particularly in micro-drives.

### SUMMARY OF THE INVENTION

It is therefore an object of the present invention to provide a disk drive including a drive assembly which reduces storage capacitor costs and related methods.

In accordance with the present invention, it has been determined that the cost of providing an external storage capacitor able to store enough power for retracting and parking the head-carrying arm of a disk drive (i.e., ramp unloading) after turning off the power supply to the drive (or to the device to which the drive belongs), may be essentially halved with respect to prior art devices. Generally speaking, the present invention uses a different approach than prior art devices for transferring energy from an external storage capacitor to the VCM after switching off the power supply to the drive. More particularly, instead of using a classical linear voltage regulator, in accordance with the present invention a dedicated auxiliary pulse width modulation (PWM) control circuit is used. Yet, the same amount of energy stored in the dedicated external capacitor is capable of driving the VCM for a duration of more than twice than maximum duration achieved by using a classical linear voltage regulator.

Accordingly, the size of the external storage capacitor used for parking the head-carrying arm of the disk drive may be reduced by half (or more) as well. Of course, in many applications this would translate into halving of the cost of the storage capacitor(s) as well.

### BRIEF DESCRIPTION OF THE DRAWINGS

FIG. 1 is a schematic block diagram of a driving circuit for powering the ramp unloading phase of a disk drive according to the prior art.

FIG. 2 is a schematic block diagram of a driving circuit for powering a ramp unloading phase according to the present invention.

FIG. 3 is a schematic block diagram of an alternative embodiment of the driving circuit of FIG. 2.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers and symbols refer to like elements throughout.

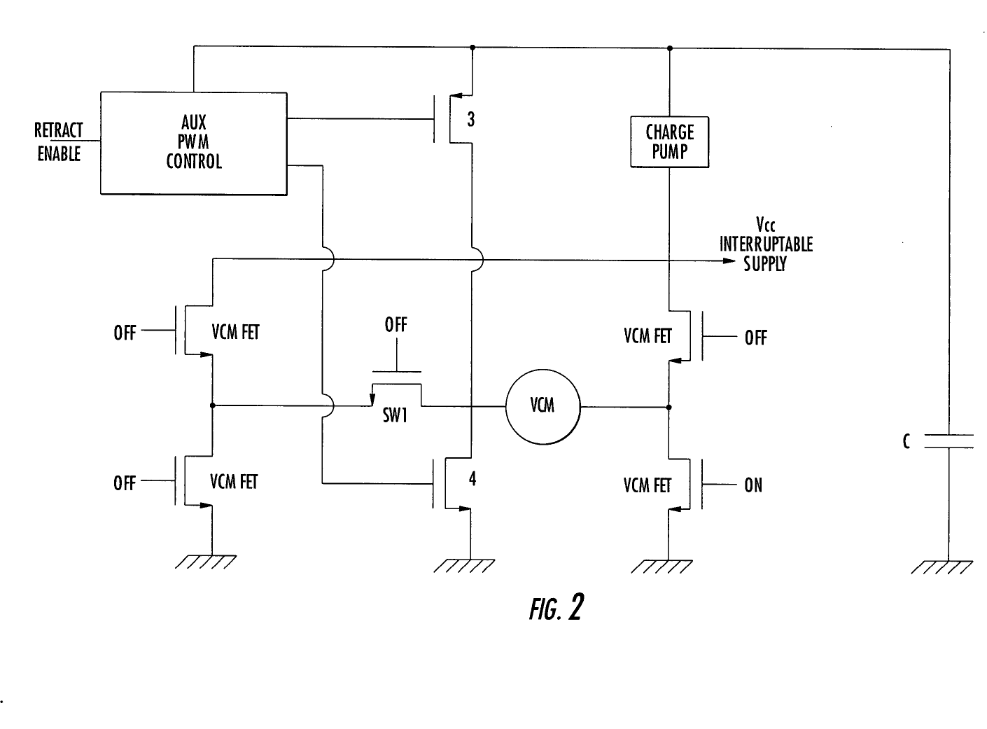

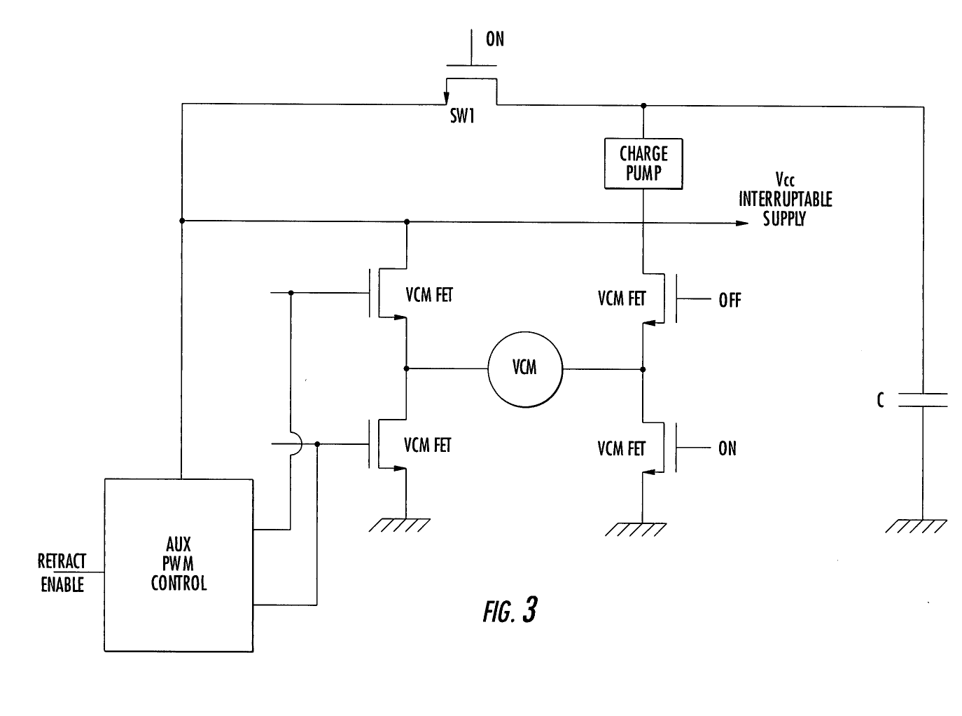

By way of example, FIGS. 2 and 3 illustrate the case in which the VCM that moves the arm carrying the read/write heads of a rotating disk drive is driven through a full bridge output stage including four field effect transistors VCM FET. The control circuitry for controlling VCM operation when the power supply is switched on is not shown for clarity of illustration. However, such circuitry is well known to those skilled in the art, and it is not used for powering the ramp unloading phase of the VCM after turning off the power supply Vcc to the drive.

Indeed, the control system of the drive, including that of the VCM, may be of any known type. Further, driving of the VCM through a full-bridge output stage, as illustrated in FIGS. 2 and 3, or through a half-bridge output stage, may be implemented in a linear mode or in a PWM mode. This may be done, for example, as described in the above-identified U.S. Pat. No. 6,542,324, which is hereby incorporated herein in its entirety by reference.

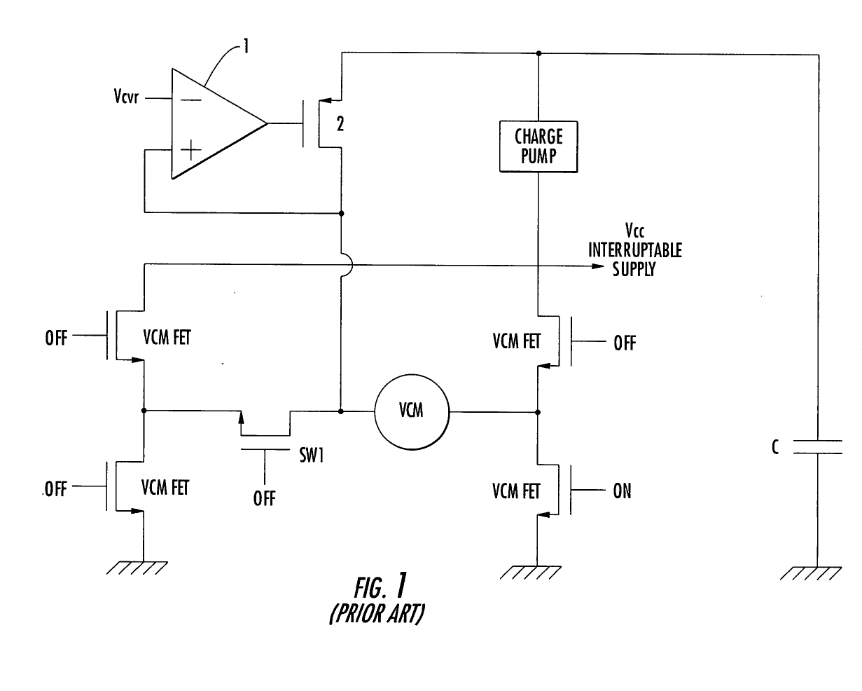

As discussed above with reference to FIG. 1, the common practice of powering the ramp unloading phase using a dedicated external capacitor C uses a classical linear voltage regulator. This regulator includes an operational amplifier 1 and a power field effect transistor 2, which maintain at the VCM a voltage V_{CVR} as long as the charge stored in the capacitor C permits.

In each of FIGS. 1-3, the external storage capacitor C is illustratively charged to a boosted voltage generated internally by a common charge pump. The charge pump may be used for other purposes as well, as noted above. Enabling the auxiliary powering of the VCM after the external power supply Vcc is interrupted (i.e., switched off) is effected by switching the V_{CVR} input node to the nominal voltage level required by VCM. Moreover, the switch SW1 is turned off to isolate the VCM from the inactive branch of the output bridge. Additionally, the low-side VCM FET of the right-hand branch of the output bridge is placed in a conducting state.

According to equation (1) above, with the following parameters representative of an exemplary micro-drive specification, an external capacitance C of 66 μF provides a driving duration of the VCM for 2.1 ms, which is sufficient to complete the ramp unloading phase upon turning off the power.

In accordance with the embodiment of the present invention illustrated in FIG. 2, an auxiliary PWM control circuit AUX PWM CONTROL is used (in place of the operational amplifier 1 of the linear voltage regulator of the prior art) for generating the complementary control phases of the auxiliary half-bridge output stage including the CMOS transistors 3 and 4. Switching off the isolation switch SW1 and placing the low side VCM FET of the right-hand branch of the full bridge output stage of the VCM control circuit in a conducting state is accomplished as similarly described above with respect to FIG. 1.

Upon turning off the power supply Vcc, the auxiliary control circuit AUX PWM CONTROL is enabled by the Retract Enable signal, and it generates the complementary PWM control phases for the CMOS pair 3 and 4 to drive the VCM motor in a PWM mode. This is done as long as the energy stored in the external capacitor C permits.

It has been verified that for identical specification values of the micro-drive, according to the circuital arrangement of the present invention the VCM motor was effectively driven for a total time of 4.7 ms. Significantly, this duration is more than twice the duration of that achieved with a classical linear voltage regulator of the prior art, using the same external capacitor of 66 μF. As a result, it was therefore possible to use an external capacitor of half the size, i.e., 33 μF, yet still ensure the full execution of the ramp unloading phase in the same micro-drive.

In the alternative embodiment illustrated in FIG. 3, the left-hand half-bridge of the output stage of the VCM control circuit is conveniently also used for the ramp unloading phase. Upon turning off the external power supply Vcc, the switch SW1 that isolates the boosted voltage source from the supply node of the output bridge during normal operation of the drive closes. The auxiliary control circuit AUX PWM CONTROL is then enabled by the Retract Enable signal, and it generates the complementary PWM control phases for the devices that form the left-hand half bridge. This drives, in a PWM mode, the VCM motor as long as the energy stored in the external capacitor C permits.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

1. A disk drive comprising:
a housing;
a rotatable data storage disk and associated disk drive motor carried by said housing for rotating said rotatable data storage disk;
a movable arm and associated arm drive motor carried by said housing for moving said arm adjacent to said rotatable data storage disk;
at least one read/write head carried by said arm;
at least one capacitor connected to a power supply; and
a driving circuit for said arm drive motor comprising
at least one output stage connected to the power supply for driving said arm drive motor, and
an auxiliary pulse width modulation (PWM) control circuit connected to said at least one capacitor for driving said at least one output stage in a PWM mode after the power supply is switched off using charge stored in said at least one capacitor.

2. The disk drive of claim 1 wherein said at least one output stage comprises a pair of half-bridge output stages; and wherein said auxiliary PWM control circuit drives one of said half-bridge output stages in the PWM mode after the power supply is switched off.

3. The disk drive of claim 1 wherein said at least one output stage comprises a primary output stage for driving said arm control motor when the power supply is switched on, and an auxiliary output stage connected to said auxiliary PWM control circuit for driving said arm control motor when the power supply is switched off.

4. The disk drive of claim 3 wherein said primary output stage comprises a full-bridge output stage, and wherein said auxiliary output stage comprises a half-bridge output stage.

5. The disk drive of claim 1 wherein said arm drive motor comprises a voice coil motor (VCM).

6. The disk drive of claim 1 wherein said driving circuit further comprises a charge pump circuit connected between the power supply and said at least one capacitor.

7. The disk drive of claim 1 wherein said at least one capacitor has a capacitance value of less than or equal to about 33 μF.

8. The disk drive of claim 1 wherein said auxiliary PWM control circuit drives said at least one output stage until said arm drive motor moves said movable arm to a parking position.

9. The disk drive of claim 1 wherein said driving circuit comprises an integrated driving circuit.

10. An electronic device comprising:
a power supply;
a processor connected to said power supply; and
a disk drive connected to said power supply to be accessed by said processor, said disk drive comprising
a housing,
a rotatable data storage disk and associated disk drive motor carried by said housing for rotating said rotatable data storage disk,
a movable arm and associated arm drive motor carried by said housing for moving said arm adjacent to said rotatable data storage disk,
at least one read/write head carried by said arm,
at least one capacitor connected to said power supply, and
a driving circuit for said arm drive motor comprising
at least one output stage connected to said power supply for driving said arm drive motor, and
an auxiliary pulse width modulation (PWM) control circuit connected to said at least one capacitor for driving said at least one output stage in a PWM mode after said power supply is switched off using charge stored in said at least one capacitor.

11. The electronic device of claim 10 wherein said at least one output stage comprises a pair of half-bridge output stages; and wherein said auxiliary PWM control circuit drives one of said half-bridge output stages in the PWM mode after said power supply is switched off.

12. The electronic device of claim 10 wherein said at least one output stage comprises a primary output stage for driving said arm control motor when said power supply is switched on, and an auxiliary output stage connected to said auxiliary PWM control circuit for driving said arm control motor when said power supply is switched off.

13. The electronic device of claim 12 wherein said primary output stage comprises a full-bridge output stage, and wherein said auxiliary output stage comprises a half-bridge output stage.

14. The electronic device of claim 10 wherein said arm drive motor comprises a voice coil motor (VCM).

15. The electronic device of claim 10 wherein said driving circuit further comprises a charge pump circuit connected between said power supply and said at least one capacitor.

16. The electronic device of claim 10 wherein said at least one capacitor has a capacitance value of less than or equal to about 33 μF.

17. The electronic device of claim 10 wherein said auxiliary PWM control circuit drives said at least one output stage until said arm drive motor moves said movable arm to a parking position.

18. The electronic device of claim 10 wherein the electronic device comprises a portable electronic device, and wherein said disk drive comprises a micro-disk drive.

19. The electronic device of claim 10 wherein said driving circuit comprises an integrated driving circuit.

20. A driving circuit for a read/write arm drive motor of a disk drive comprising at least one capacitor connected to a power supply, the driving circuit comprising:
at least one output stage connected to the power supply for driving the arm drive motor; and
an auxiliary pulse width modulation (PWM) control circuit connected to said at least one capacitor for driving said at least one output stage in a PWM mode after the power supply is switched off using charge stored in said at least one capacitor.

21. The driving circuit of claim 20 wherein said at least one output stage comprises a pair of half-bridge output stages; and wherein said auxiliary PWM control circuit drives one of said half-bridge output stages in the PWM mode after the power supply is switched off.

22. The driving circuit of claim 20 wherein said at least one output stage comprises a primary output stage for driving the arm control motor when the power supply is switched on, and an auxiliary output stage connected to said auxiliary PWM control circuit for driving the arm control motor when the power supply is switched off.

23. The driving circuit of claim 22 wherein said primary output stage comprises a full-bridge output stage, and wherein said auxiliary output stage comprises a half-bridge output stage.

24. The driving circuit of claim 20 wherein said at least one capacitor has a capacitance value of less than or equal to about 33 μF.

25. A method for driving a read/write arm drive motor of a disk drive comprising:
driving the arm drive motor using at least one output stage when a power supply connected thereto is switched on;
charging at least one capacitor connected to the power supply when the power supply is switched on; and
driving the at least one output stage in a pulse width modulation (PWM) mode after the power supply is switched off using charge stored in the at least one capacitor.

26. The method of claim 25 wherein the at least one output stage comprises a pair of half-bridge output stages; and wherein driving the at least one output stage in a PWM mode comprises driving one of the half-bridge output stages in the PWM mode after the power supply is switched off.

27. The method of claim 25 wherein the at least one output stage comprises a primary output stage for driving the arm control motor when the power supply is switched on, and an auxiliary output stage for driving the arm control motor when the power supply is switched off.

28. The method of claim 27 wherein the primary output stage comprises a full-bridge output stage, and wherein the auxiliary output stage comprises a half-bridge output stage.
